(19) United States
(12) Patent Application Publication
(10) Pub. No.: US 2016/0160787 A1
(43) Pub. Date: Jun. 9, 2016

(54) CONTROLLER FOR CONTROLLING AN INTERNAL COMBUSTION ENGINE OF A VEHICLE, IN PARTICULAR A COMMERCIAL VEHICLE

(71) Applicant: Daimler AG, Stuttgart (DE)

(72) Inventors: Marc C. Allain, Plymouth, MI (US); Peter Attema, Ann Arbor, MI (US); Christopher Atkinson, Morgantown, WV (US)

(73) Assignee: Daimler AG, Stuttgart (DE)

(21) Appl. No.: 14/958,378

(22) Filed: Dec. 3, 2015

(30) Foreign Application Priority Data
Dec. 4, 2014 (GB) 1421591.7

(51) Int. Cl. F02D 41/26

(52) U.S. Cl. CPC F02D 41/263

(57) ABSTRACT

A controller for controlling an internal combustion engine of a vehicle is disclosed. The controller includes at least one real-time dynamic computational model of at least a part of the internal combustion engine, at least one offline optimized set-point as a first input to the computational model, at least one physical engine sensor input as a second input to the computational model, and a real-time optimizer configured to adjust at least one engine control signal on the basis of at least one output of the computational model in such a way that a deviation from a set-point is at least decreased.

This application claims the priority of Great Britain Patent Application No. GB 1421591.7, filed Dec. 4, 2014, the disclosure of which is expressly incorporated by reference herein.

### BACKGROUND AND SUMMARY OF THE INVENTION

The invention relates to a controller for controlling an internal combustion engine of a vehicle.

US 2011/026 4353 A1 shows an internal combustion engine controller, comprising at least one computational model, at least one physical engine sensor input, at least one predetermined control input, and at least one output, wherein the computational model utilizes inverse modeling to determine the at least one control input.

Low emission, high efficiency internal combustion engines continue to increase in sophistication with their rapid proliferation of additional engine sensors and control actuators. This complexity increases the number of independently controllable parameters and calibration variables, which in turn increases the control system development burden. Current algorithm-based engine controls generally focus on fuel injection strategies, air path control, exhaust gas recirculation (EGR) and after-treatment management. Due to complex dynamic interactions between these control parameters, effective strategies are difficult to develop from a first-principles' basis and time-consuming to calibrate under transient real-world operation. Conventional engine control involves the development of multiple functions and algorithms to control air management, exhaust management, fuel injection, and active after-treatment control.

Diesel engine control today is predominantly feed-forward open loop control with hundreds or thousands of independent calibrateable parameters or pre-mapped data points. Feed-forward open loop control is also susceptible to the effects of extraneous disturbances or noise, sensor drift and general degradation of sensors and actuators. As a result conventional engine control requires a significant, ongoing effort in function development and downstream engine calibration using expensive engineering resources.

Consequently, significant control tuning (mainly conducted manually using ad-hoc time and effort-intensive methods) is required for control system development and optimization as this mode of control is well-suited for steady-state operation, and not for the transients that characterize real-world engine operation. The pressure to improve engine control is based on the desire to improve real-world fuel efficiency while maintaining the same or reduced emission levels, improving dynamic engine performance and reducing the accompanying calibration, diagnostics and prognostics burden in order to reduce engineering effort and costs.

An alternative approach to this traditional effort-intensive method of developing engine control is the implementation of real-time, on-board model-based control. Model-based calibration optimization methods have shown their efficacy in the offline engine development process but to date have had limited success in on-line, real-time engine controls.

Model-based control (MBC) systems may be generally implemented in connection with an internal combustion engine (e.g., a compression ignition or diesel engine) having multiple inputs, such as engine rotational speed as measured in crankshaft revolutions per minute (RPM), fueling rate, exhaust gas recirculation (EGR) rate, airflow rate, injection timing (BOI), injection pressure, intake temperature, RPM gradient and fueling rate gradient. MBC systems may be used as a means of controlling turbocharged diesel engines with variable geometry turbocharging (VGT) and EGR due to the difficulties of predicting and controlling dynamic turbocharger response using conventional table-based control methods. MBC methods may also be used to improve an engine calibration process, again as an alternative to conventional map (look-up tables) or table-based methods.

The development of MBC systems includes high-fidelity dynamic engine models, which may predict engine performance, emissions and operating states at high computational rates. These dynamic models are based on a combination of physics-based modeling and data-driven techniques. Physics-based models are based on first principal physics, chemical and thermodynamic equations. An exemplary MBC system allows for adaptation to compensate fuel property variations, sensor drift and engine sensor actuator degradation, which can reduce the effort required for the calibration optimization of highly complex engines.

It is an objective of the present invention to provide a controller for controlling an internal combustion engine of a vehicle, which controller allows for reducing calibration complexity, improving transient engine performance and reducing fuel consumption.

The invention relates to a controller for controlling an internal combustion engine of a vehicle such as, for example, a commercial vehicle. For example, the engine is a diesel engine. The controller according to the present invention includes at least one real-time dynamic computational model of at least a part of the internal combustion engine operation or performance. The controller further includes at least one offline optimized set-point as a first input to the computational model, and at least one physical engine sensor input as a second input to the computational model. Furthermore, the controller includes a real-time optimizer configured to adjust at least one engine control signal on the basis of at least one output of the computational model in such a way that a deviation from the set-point is at least decreased. One example of such a controller might have as a set-point a variable relating to the phasing of combustion in the internal combustion engine.

The idea behind the invention is that traditional engine controllers rely on calibration intensive, table-based functions. This may be well-suited for steady state operation, but not for transient operation which characterizes real-world operation. The invention is an alternative approach to controlling engine performance, including fuel efficiency and emissions production, through the use of traditional calibration-intensive control algorithms. The invention relies on pre-developed engine performance models operating real-time or faster than real-time on-board an engine controller. The calculated outputs of the transient engine models are used as part of an optimization function to calculate optimum engine actuator set-points in real-time. By reducing calibration complexity, the invention can reduce engine development time. By enabling transient engine optimization, the invention can reduce over the road fuel consumption and vehicle cost of ownership, while retaining low exhaust emissions levels. For example, empirical, data-driven models can be used in conjunction with table-based look-up developed offline (using the same or similar models) to steer the real-time optimization.

In other words, according to the present invention, the combustion timing is a performance target so that, for example, the optimizer adjusts the at least one engine control signal in such a way that the performance target is reached. For example, the combustion timing may relate to the crank angle at which 50% of the fuel contained in at least one combustion chamber of the internal combustion engine has burned, where the time is also referred to as CA50. Preferably, a set of offline-optimized set-points, e.g., injection timing, pressure, waste gate position, etc., is used to steer the online optimization towards a search landscape that, from a steady-state stand point, is close to optimum performance. Moreover, preferably, inverse models are not used in the invention. However, combustion timing is used in the optimization function, where a great number of optimizer iterations is conducted.

Further advantages, features, and details of the invention derive from the following description of a preferred embodiment as well as from the drawings. The features and feature combinations mentioned in the description as well as the features and feature combinations mentioned in the following description of the figures and/or shown in the figures alone can be employed not only in respective indicated combinations but also in any other combination or taken alone without leaving the scope of the invention.

### BRIEF DESCRIPTION OF THE DRAWINGS

FIG. 1 is an illustration of a controller for controlling an internal combustion engine of a vehicle according to the present invention;

FIG. 2 is an illustration of an internal combustion engine control method according to the present invention; and

FIG. 3 is an equation used to control the internal combustion engine.

### DETAILED DESCRIPTION OF THE DRAWINGS

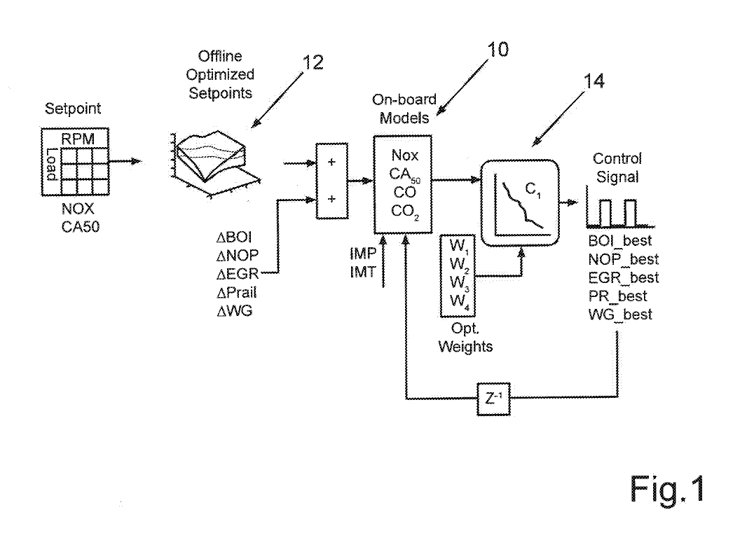

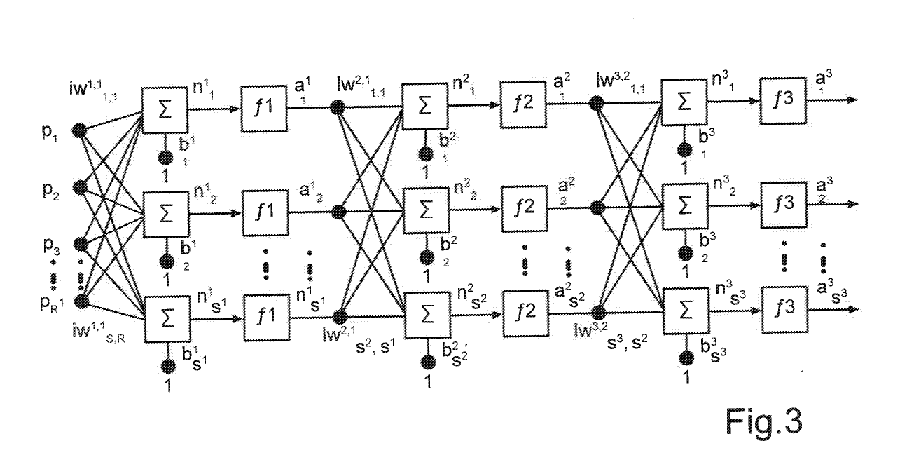

FIGS. 1 to 3 illustrate a controller for controlling an internal combustion engine of a vehicle, the controller including at least one real-time dynamic on-board computational model of at least a part of the internal combustion engine operation, at least one set of offline-optimized set-points as a first input to the computational model, at least one physical engine sensor input as a second input to the computational model, and a real-time optimizer configured to adjust at least one engine control signal on the basis of at least one output of the computational model in such a way that a deviation from the targeted set-point is at least decreased. As an example hereof the set-point may relate to a combustion timing of the internal combustion engine. Unlike traditional control strategies widely used in the industry today, the controller is a data-driven model-based predictive controller, which estimates emissions, fuel economy and other critical performance parameters in real-time (or faster). It also uses non-traditional calibration targets and an on-board optimization routine that minimizes controller error as well as emissions production, including transient smoke, NOₓ and CO₂ production.

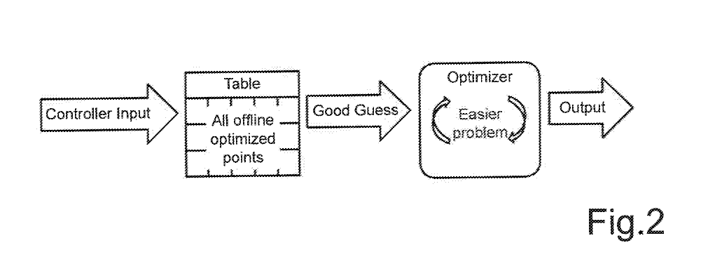

FIG. 1 shows three main components of the controller forming a next generation model-based engine control system. The control system includes one or more real-time dynamic predictive engine models 10 which are computational models of the performance of the internal combustion engine. The system further includes a set 12 of offline optimized engine set-points as well as a real-time optimizer 14. The offline optimized set-points illustrated in FIG. 2 are calculated using predictive engine performance and emissions models in off-line simulation. FIG. 2 is an illustration of the controller's two step optimization. The models are exercised extensively for a range of engine control parameters (e.g., injection timing, pressure, etc.) at a number of discrete engine speeds and fueling rates under simulated steady (or transient) operation. As can be seen from FIG. 1, one of the set-points may relate to a combustion timing or phasing CA50 of the internal combustion engine, where the combustion timing or phasing CA50 is a time (or crank angle position) at which 50% of the fuel contained in a combustion chamber of internal combustion engine has burned. For example, the combustion chamber is a cylinder of the engine.

The results obtained at each speed and load combination are then ranked in tradeoffs of NOx-CO, NOx-CO2 in a pareto ranking, and the optimum engine control set-point combinations for a range of values along the emission trade-off curves are used to populate pre-optimized set-point tables. These pre-optimized set-points are then used as the starting points in determining the optimum set of controlled inputs at any speed and load, for a given NOₓ emission target (or for a given NOₓ emissions target in conjunction with other engine operating output targets). The optimization problem to be solved by the controller, in particular the optimizer 14, involves exploring the engine performance landscape around the pre-computed set-points and minimizing a pre-established cost function corresponding to each set of candidates. The cost function includes variable rates assigned to the effect of each target or cost parameter, which might include engine performance, emissions and operating targets. Once the optimum value of the cost function has been established, the control parameter set corresponding to that optimum value is then output to the engine or stored.

The real-time dynamic predictive engine models are forward models that may predict engine performance, engine operation, engine emissions and engine response for a wide range of transient engine controls and operating inputs. The real-time model captures full engine dynamic operating conditions such as inertial effects, the dynamics of induction and exhaust gas exchange, including turbo-charging and EGR, full mechanical dynamics and full combustion effects. The operating inputs required for the control are received from existing or added engine sensors. These operating inputs may include engine speed (RPM), fueling rate, intake pressure (IMP), intake temperature (IMT), ambient pressure, rail pressure (Prail), selective catalytic reduction (SCR) inlet temperature, diesel particulate filter (DPF) inlet pressure, fuel injection timing (BOI), pilot injection quantity and EGR valve setting. These known operating inputs (and the history of their behavior) are used in conjunction with the engine operating conditions, which are used to create set-points for further calculations that will be discussed in greater detail below. The operating conditions may also include speed and fueling, to calculate instantaneous output torque, NOₓ, PM, CO, HC and CO2 emissions levels at each of multitude of time steps.

After the initial operating inputs from the engine data have been captured and analyzed, the dynamic or transient engine models are developed. The dynamic or transient engine models are created using a combination of physical and heuristic modeling to capture the full inertial, thermal, combustion and gas exchange dynamics of typical engine operation. This approach requires a range of timescales to be captured in the modeling, which in turn requires the underlying data contain those transient features. The heuristic portion of the modeling effort includes a data driven learning process that is able to generalize predictions within the range of engine operation seen in the operating data inputs.

These models may include empirical data-driven models trained with experimental data to recognize input-output relationships and the dynamics of engine systems. Typical models may have 8 to 10 inputs (engine speed, fueling rate, EGR rate, airflow rate, injection timing (BOI), injection pressure, intake temperature, intake pressure, RPM gradient, fueling rate gradient).

The dynamic engine models may also utilize the immediate operating history of the engine to determine the transient trajectory of the output parameters, thus creating a truly dynamic modeling environment. The specific extent of the history required is determined through an experimental modeling process to best match the underlying engine data.

Once these models (or derivative versions thereof) have been developed and proven to predict engine performance, emissions production and fuel efficiency to a desired level of accuracy and validity, the models are used both in the off-line simulation environment to produce the initial candidate tables of engine control actuator set-points, and in the on-line real-time computational environment for the calculation of optimized real-time control actuator output.

The results calculated from the real-time engine models using the current values (and potentially previous history) of the engine operating parameters, are then used in a real-time optimization calculation to determine whether they reach or exceed certain pre-determined or variable target levels. Each engine output target can be assigned a fixed or variable weighting in the optimization, minimization or cost function. These weights can be developed from existing knowledge of suitable engine performance or from knowledge of desired levels of performance.

The optimization function is typically calculated for a minimum of one time, or for a maximum number of times up to the point at which a set of control actuator outputs must be sent to the engine to ensure stable, safe and efficient on-going control. The optimization function may contain terms associated with meeting, exceeding or under-shooting targets for calculated or measured engine outputs. The various individual terms in the optimization function maybe weighted by pre-set or variable weights, and the optimization function might be minimized, maximized or merely observed.

### LIST OF REFERENCE CHARACTERS

10 real-time dynamic predictive engine models
12 set of offline optimized engine set-points
14 real-time optimizer

The foregoing disclosure has been set forth merely to illustrate the invention and is not intended to be limiting. Since modifications of the disclosed embodiments incorporating the sprit and substance of the invention may occur to persons skilled in the art, the invention should be constructed to include everything within the scope of the appended claims and equivalents thereof.

What is claimed is:

1. A controller for an internal combustion engine, comprising:
a real-time dynamic computational model of a performance of a part of the internal combustion engine;
a control target related to engine performance or emissions or fuel consumption;
an offline optimized control set-point as a first input to the computational model;
a physical engine sensor input as a second input to the computational model; and
a real-time optimizer configured to adjust an engine control signal on a basis of an output of the computational model such that a deviation from the control target is at least decreased.

2. The controller according to claim 1, wherein the output is related to engine performance or emissions or fuel consumption.

3. The controller according to claim 1, wherein the second input is a recorded sensor or actuator signal value.

4. The controller according to claim 1, wherein the control target is related to combustion phasing or an engine emissions output.

5. The controller according to claim 1, wherein an injection timing, an injector actuator setting, an exhaust gas recirculation actuator setting, an injection pressure, and a turbocharger actuator setting are inputs to the computational model.

6. The controller according to claim 1, wherein the real-time optimizer regulates at least one of an injection timing, an injector actuator setting, an exhaust gas recirculation actuator setting, an injection pressure, and a turbocharger actuator setting.

7. The controller according to claim 1, wherein the real-time optimizer includes a function related to a deviation between the output and the control target.

8. A method for controlling an internal combustion engine by a controller according to claim 1.
